(19) United States
(12) Patent Application Publication
(10) Pub. No.: US 2025/0149013 A1
(43) Pub. Date: May 8, 2025

(54) CONTROL SYSTEM FOR PERSONAL STAGE MONITORING AND MIXING SYSTEMS

(71) Applicant: Shure Acquisition Holdings, Inc., Niles, IL (US)

(72) Inventors: Sergio Alvarez, Chicago, IL (US); Marianela Schanz, Wilmette, IL (US); Bryan Jozwiak, Bartlett, IL (US); Leif Moravy, Chicago, IL (US); Jonathan Portwood, Vernon Hills, IL (US)

(73) Assignee: Shure Acquisition Holdings, Inc., Niles, IL (US)

(21) Appl. No.: 19/016,808

(22) Filed: Jan. 10, 2025

Related U.S. Application Data
(63) Continuation-in-part of application No. 18/631,230, filed on Apr. 10, 2024.
(60) Provisional application No. 63/495,621, filed on Apr. 12, 2023.

(51) Int. Cl. G10H 1/00; G10H 1/46; H04W 76/15

(52) U.S. Cl. CPC G10H 1/0058; G10H 1/46; H04W 76/15; G10H 2250/311

(57) ABSTRACT

Aspects of the disclosure relate to personal stage monitoring (PSM) systems and methods. A PSM system may include a transmitter and a receiver, where the transmitter may transmit audio data to the receiver to provide performers with monitoring feedback. The PSM transmitter may include audio processing and/or personal mixing devices that provide a customized mix of audio signals that may be transmitted to the receiver. The PSM transmitter and/or PSM receiver of the PSM system may include controller that facilitate a remote control of the other of the other device.

### CROSS REFERENCE TO RELATED APPLICATIONS

This patent application is a continuation-in-part application of U.S. application Ser. No. 18/631,230, filed Apr. 10, 2024, which claims priority to, and the benefit of, U.S. Provisional Patent Application No. 63/495,621, filed Apr. 12, 2023, each of which is incorporated herein by reference in its entirety.

### TECHNICAL FIELD

Aspects of the disclosure relate to mixing and personal stage monitoring (PSM) systems and more specifically to mixing and PSM systems including adaptive control systems for cross device control.

### BACKGROUND

Live performance environments, such as music concerts, theatrical productions, and other events, require enabling performers to hear themselves and other performers clearly in order to deliver their best performance.

An audio system may include a PSM system to provide performers with monitoring feedback using, for example, monitoring speakers on stage or in-ear monitors (IEMs). Feedback to the performers allows performers to hear themselves and other performers more clearly, even in noisy environments. To process the audio feedback, the audio system may further include audio processing and mixing devices that supply the PSM system with processed audio signals that are then provided to the respective performer using the PSM system. In such multi-device systems, the performers and/or other users having PSM receivers (e.g., IEMs) are limited to local audio adjustments via the interface(s) of the PSM receiver without the ability to provide feedback and/or control to other components of the audio system, such as the PSM transmitter, mixer, and/or other components of the system. These limitations may impact audio quality and/or system operation.

### SUMMARY

Aspects of the disclosure provide effective, scalable, and reliable technical solutions that address and overcome the problems associated with operation of complex audio systems including mixing and PSM systems.

An example audio system may include a chain of discrete subcomponents, each configured to perform a specific audio processing functionality. For example, the subcomponents may include microphones, receivers, mixers, amplifiers, speakers, a PSM system, musical instruments, general-purpose computing devices, etc.

A PSM system may include a transmitter (Tx) and a receiver (Rx), where the transmitter may transmit audio data to the receiver to provide performers with monitoring feedback. The receiver may be one or more monitoring speakers on stage, or a portable device worn by the performer that may include an audio output, such as in-car monitors (IEMs). Feedback to the performers may allow performers to hear themselves, instruments, audio tracks, and/or other performers more clearly, even in noisy environments. To tailor the feedback, the PSM transmitting device may include audio processing and/or mixing devices that provide a customized mix of audio signals that may be transmitted to the receiving device. Such a configuration may provide a PSM system with personal mixing for one or more performers. Additionally, or alternatively, the mixer may include a PSM transmitting device to transmit audio data to the PSM receiver. The integration of the audio processing and/or mixing devices with the PSM transmitting device, and/or the integration of the PSM transmitting device with the audio processing and/or mixing devices, advantageously reduces the complexity of the overall audio system by, for example, reducing the number of discrete components making up the audio system and/or reducing the necessary connections between devices. Further advantageous may include improved audio quality and performance by reducing noise (e.g. that may be introduced from wired and/or wireless connections) and/or reducing latency of the audio system.

One or more of the components of the audio system may include a controller configured to control one or more other components of the audio system, provide data to the other component(s), and/or receive data from the other component(s), including requesting data from the other component(s). To facilitate the control of the other component(s) and/or exchange of information, the respective controllers may communicate with the respective controller of the other component(s) using one or more wireless communication protocols. For example, the controller of the PSM receiver may control the PSM transmitter and/or the mixer, and/or provide data and/or information to the PSM transmitter and/or mixer.

### BRIEF DESCRIPTION OF THE DRAWINGS

The present disclosure is illustrated by way of example and not limited in the accompanying figures in which like reference numerals indicate similar elements and in which:

FIG. 1 shows an audio system according to one or more exemplary embodiments.

FIG. 2 shows an audio system according to one or more exemplary embodiments.

FIG. 3A shows an example operation of a mixer according to one or more exemplary embodiments.

FIG. 3B shows an example operation of a PSM system according to one or more exemplary embodiments.

FIG. 3C shows an example operation of a PSM system according to one or more exemplary embodiments.

FIG. 4A shows a PSM system, according to one or more exemplary embodiments, including a PSM transmitter having a personal mixer.

FIG. 4B shows an audio system, according to one or more exemplary embodiments, including a mixer having a PSM transmitter.

FIG. 5A shows an example operation of a PSM system having an integrated personal mixer according to one or more exemplary embodiments.

FIG. 5B shows an example operation of a mixer having an integrated PSM transmitter according to one or more exemplary embodiments.

FIG. 6 shows an audio system including a user device according to one or more exemplary embodiments.

FIG. 7 shows an audio system with integrated mixing and PSM components and

including a user device according to one or more exemplary embodiments.

FIG. 8 shows an electronic device (e.g., user device) usable with an audio system according to one or more exemplary embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

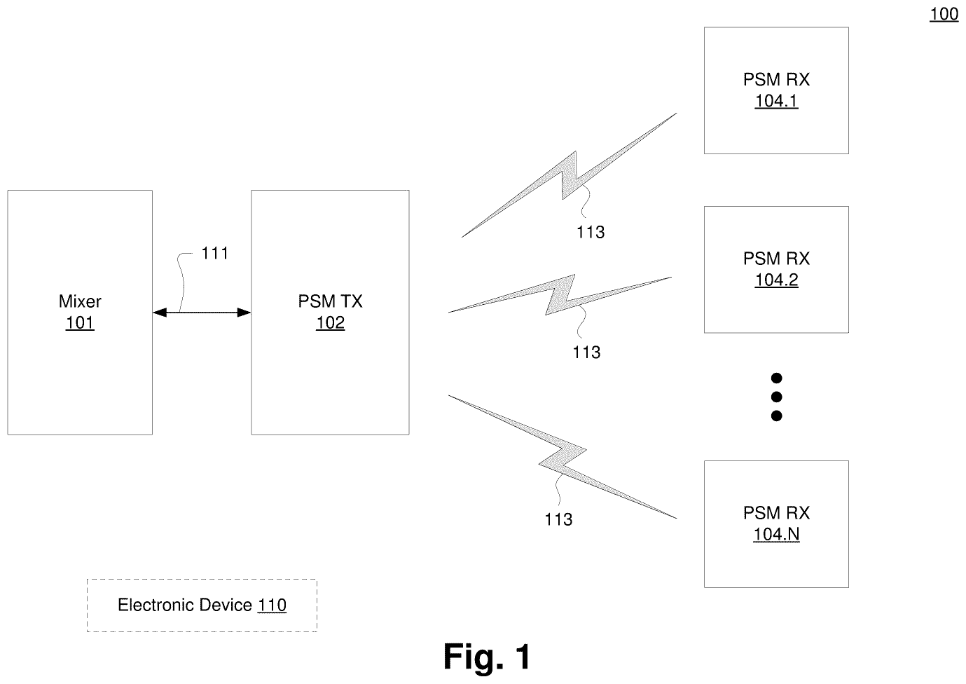

With reference to FIG. 1, an audio system 100 according to one or more exemplary embodiments may include a mixer 101 and a personal stage monitoring (PSM) system, having a PSM transmitter (PSM Tx) 102 and one or more PSM receivers (PSM Rx) 104. The system 100 may include one more electronic devices 110, such as one or more computing devices (e.g., desktop computer, laptop computer), mobile computing device (e.g., smartphone, tablet), and/or any other type of device that may be used for one or more audio applications, which may communicate with the mixer 101, PSM transmitter 102, and/or PSM receiver(s) 104. The electronic device 110 may to control the mixer 101 (e.g., control mixing operations of the mixer 101), transmit data and/or information to the mixer 101, and/or receive data and/or information from the mixer 101. Similarly, the electronic device 110 may control the PSM transmitter 102, and/or PSM receiver(s) 104, transmit data and/or information to the PSM transmitter 102, and/or PSM receiver(s) 104, and/or receive data and/or information from the PSM transmitter 102, and/or PSM receiver(s) 104.

The PSM transmitter 102 and PSM receiver(s) 104 may be configured to communicate with each other using one or more wireless and/or wired communication protocols via one or more connections 113. The mixer 101 may be connected to the PSM transmitter 102 via connection 111 and configured to communicate with each other using one or more wireless and/or wired communication protocols. In one or more aspects, the mixer 101 may communicate with the PSM receiver 104 directly and/or indirectly via the PSM transmitter 102. The connections 111, 113 may be adapted as data and/or power connections for data and/or power transmission. In one or more aspects, the PSM transmitter 102 and/or the PSM receiver 104 may be configured as a transceiver that is configured to both transmit and receive information. The communications between the PSM transmitter 102 and PSM receiver 104 may be via one or more wireless and/or wired communication protocols.

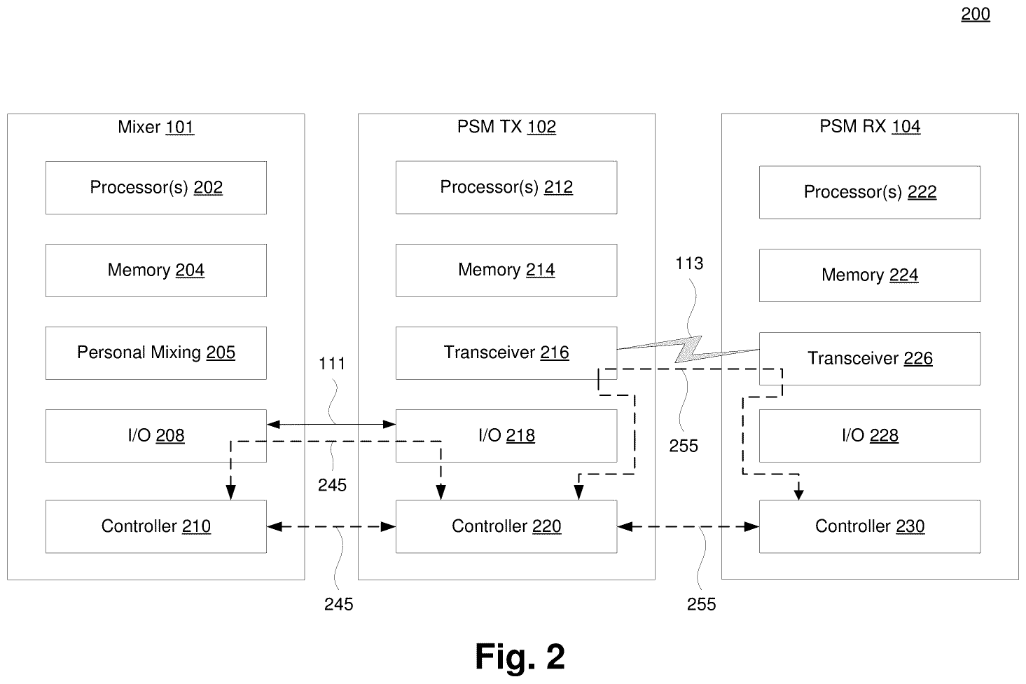

Additionally, as described in more detail below, one or more of the components of the audio system 100 may include a controller (e.g., controllers 210, 220, 230 in FIG. 2) configured to monitor and/or control of one or more other components of the audio system 100 (e.g., using one or more commands), provide data, statuses, and/or other information to the other component(s), and/or receive data, statuses, and/or other information from the other component(s), which may include requesting data, statuses, and/or other information from the other component(s). Data signals may be transmitted and/or received between the mixer 101, PSM transmitter 102, PSM receiver(s) 104, electronic device 110, and/or other components of the audio system 100. The information contained in the data signal may include commands, instructions, requests, control information, statuses, and/or other information sent and received from the components of the audio system 100 for monitoring and control purposes. For example, the controllers 210, 220, and/or 230 may transmit and receive data signals that may include commands, instructions, requests, control information, statuses, and/or other information, and may be used for monitoring and/or controlling of the various components of the audio system 100. The controller of a component may communicate with a respective controller of the other component(s) using one or more wireless and/or wired communication protocols. According to one or more exemplary embodiments, the connection(s) (e.g., connections 111, 245, 255 establishing a second communication link/connection, which may be backchannel link(s)/connection(s)) between the various controllers may be separate from the connections(s) (e.g. connection 113 providing a first communication link/connection) established between the PSM transmitter 102 and PSM receiver 104 to exchange, for example, audio data. The various connections may use the same or different communication protocols. In aspects where the same communication protocol is used for the various connections, the connections may use, for example, different frequencies and/or frequency bands.

The mixer 101 and PSM transmitter 102 may be located, for example, at a sound board or sound booth, and respectively configured to mix and transmit audio signals to the PSM receiver 104. The PSM receiver 104 may be located, for example, on the stage and associated with a monitor speaker, and/or may be implemented as a portable device that may be worn by the performer on stage. For example, the PSM receiver 104 may be worn by the performer and may include a beltpack or bodypack that is attached to the performer's belt or clothing and headphones (e.g. in-car monitors (IEMs) that fit snugly in the performer's ears). The headphones are responsible for delivering the audio signals directly to the performer's ears, allowing them to hear themselves, instruments, audio tracks, and/or other performers clearly on stage. In operation, the PSM transmitter 102 and PSM receiver 104 work together to provide a monitoring audio stream for the performer on stage. The sound engineer may provide mixed audio signals from the mixer 101 or other external mixing console or sound booth to the PSM transmitter 102, which may then transmit the audio signals to the PSM receiver 104 worn by the performer. The mixer 101 may be configured to perform personal mixing operations for one or more individual PSM receivers 104 to provide the performers with a personal mix of the audio.

The mixer 101, the PSM transmitter 102, and/or the PSM receiver 104 may be configured to transmit and/or receive signals using one or more communication protocols, such as an Institution of Electrical and Electronics Engineers (IEEE) 802.11 WIFI protocol, an IEEE 802.15.1 protocol (e.g., Bluetooth), an IEEE 802.15.4 protocol (e.g., Zigbee, Shure Inc.'s ShowLink® protocol), or one or more other wireless personal area network (WPAN) protocols, a 3rd Generation Partnership Project (3GPP) cellular protocol, a local area network (LAN) protocol, a hypertext transfer protocol (HTTP), FM radio, infrared, one or more optical protocols, fiber optics, industrial, scientific, and medical (ISM) bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHz-61.5 GHz band, etc.), a very high frequency (VHF) band (e.g., 30 MHz-300 MHz band) and/or via (e.g., one or more channels within) an ultra-high frequency (UHF) band (e.g., 300 MHz-3 GHz). The communication protocols that may be used are not limited to these example protocols.

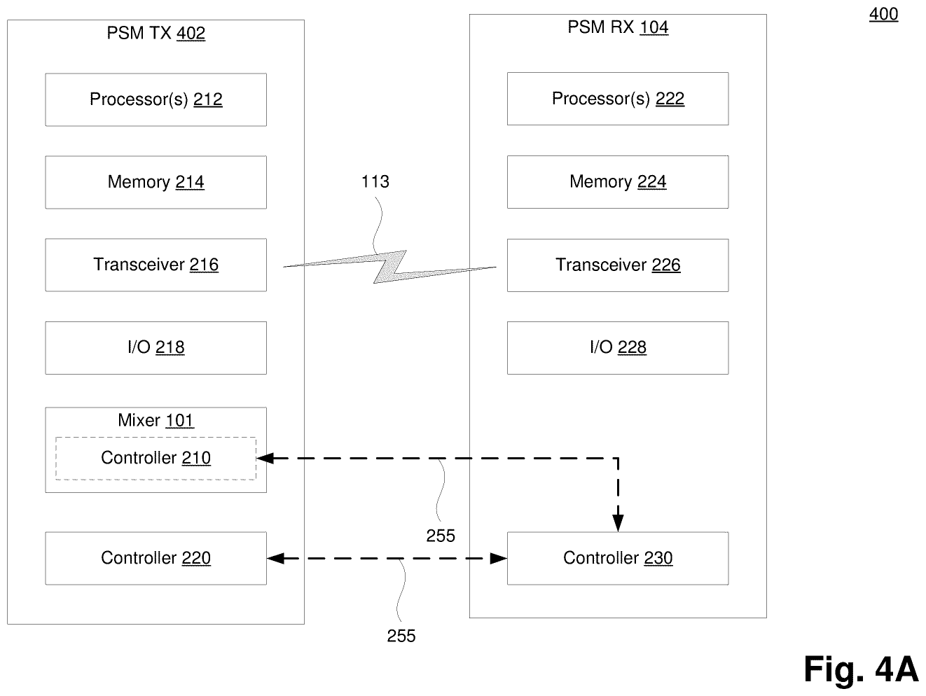

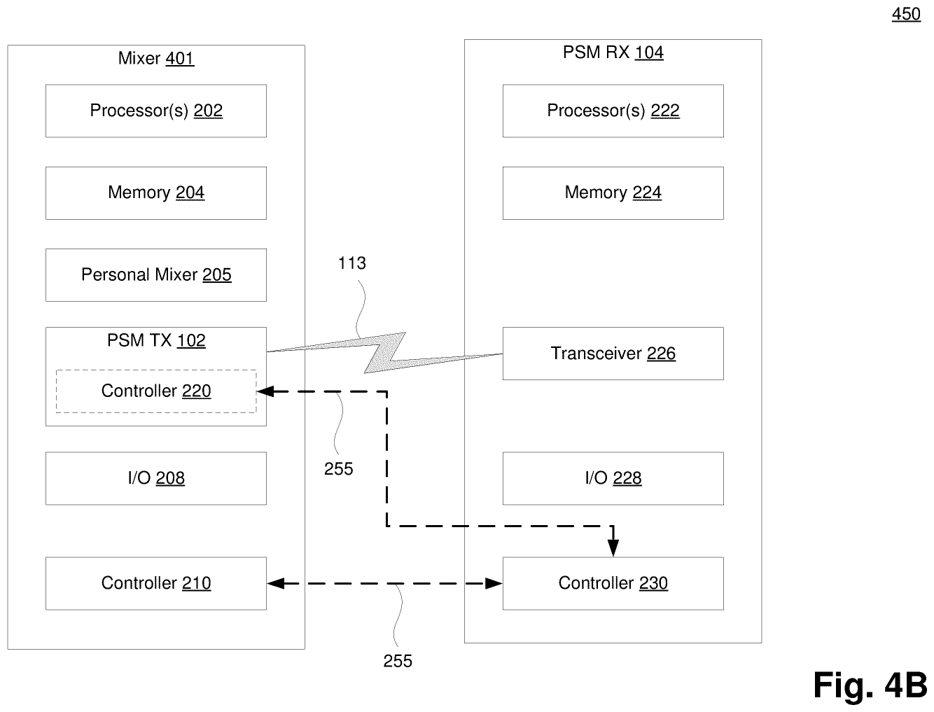

The PSM system 100 may be implemented with one or more other audio subcomponents to form an audio system that includes a chain of discrete subcomponents, each configured to perform a specific audio processing functionality. For example, the subcomponents may include microphones, receivers, mixers, amplifiers, speakers, musical instruments, general-purpose computing devices, etc. In one or more exemplary embodiments, the PSM system 100 may be integrated with one or more subcomponents of the audio system 100. For example, as illustrated in FIGS. 4A-4B, the mixer 101 (e.g., configured for personal mixing) may be integrated within the PSM transmitter 102 (FIG. 4A, showing PSM TX 402 having mixer 101), or the PSM transmitter 102 may be integrated within the mixer 101 (FIG. 4B, showing mixer 401 having PSM TX 102).

As an example, audio system 100 may receive audio from one or more microphones and/or instruments, and process the audio via a receiver, mixer 101, and/or amplifier(s), prior to outputting the audio via one or more speakers. Various examples herein describe a PSM system, or an audio system 100 comprising a PSM system, that may be connected to one or more other audio devices (e.g., microphones, speakers, musical instruments and/or instrument outputs, transmitters, receivers, transceivers, computing devices, etc.). The PSM system may be flexibly configured to receive audio input from the mixer 101 configured to mix one or more audio sources (e.g. microphone(s), instrument(s), and/or audio track(s)) and provide monitoring feedback to the performer.

With reference to FIG. 2, according to one or more exemplary embodiments, the mixer 101 may include one or more of processor(s) 202, memory 204, personal mixing module (personal mixer) 205, input/output (I/O) interface(s) 208; and/or controller 210. One or more data buses may interconnect the processor(s) 202, the memory 204, personal mixing module 205, I/O interface(s) 208, and/or controller 210. The mixer 101 may be implemented using one or more integrated circuits (ICs), software, or a combination thereof, configured to operate as described herein. The memory 204 may comprise any memory, such as a random-access memory (RAM), a read-only memory (ROM), a flash memory, or any other electronically readable memory, or the like. The memory 204 may include one or more memory units.

The processor(s) 202 may be configured to perform one or more operations of the mixer 101, including controlling the operation of the mixer 101 and/or operation of one or more of its other components. For example, the processor(s) 202 may control the personal mixer 205 to perform one or more audio mixing operations. The processor(s) 202 may execute machine readable instructions stored in memory 204 to perform one or more operations of the mixer 101. Signals received and/or output (e.g., via the I/O interface 208) by the mixer 101 may be encoded in one or more data units. For example, the processor(s) 202 may be configured to generate data units, and process received data units, that conform to any suitable wired and/or wireless communication protocol.

The personal mixer 205 may be configured to perform one or more audio mixing operations, digital signal processing (DSP), and/or other signal processing on the audio signals received (e.g. via I/O interface 208) to generate processed audio data. The processed audio data provides a customized mix of audio signals, which may then be provided to the PSM transmitter 102 to be transmitted to the PSM receiver 104 (using the transceiver 216). Such a configuration may provide an audio system with personal mixing for one or more performers. The mixing operations may be performed in the analog or digital domains. If multiple mixing operations are performed, one or more operations may be performed in the analog domain while one or more other operations may be performed in the digital domain. In an exemplary embodiment, the personal mixer 205 may include processing circuitry (e.g. one or more processors and/or circuitry) that is configured to perform the function and/or operations of the personal mixer 205.

In an exemplary embodiment, the personal mixer 205 may be configured to perform one or more mixing operations using machine learning (ML), such as using one or more ML models to adjust (e.g. optimize) mixing parameters to control the mixing operations of the personal mixer 205. The ML model may support a generative adversarial network, a bidirectional generative adversarial network, an adversarial autoencoder, or an equivalent thereof. Additionally, or alternatively, the ML model may be a convolutional neural network, a recurrent neural network, a recursive neural network, a long short-term memory (LSTM), a gated recurrent unit (GRU), an unsupervised pretrained network, a space invariant artificial neural network, or any equivalent thereof. The ML model may be trained based on input data and/or output data of the mixer 101 (e.g., personal mixer 205), PSM transmitter 102, PSM receiver 104, user device 601, one or more other components of the audio system, and/or one or more other devices in communication with the audio system. The ML model may be trained using different training techniques, such as supervised training, unsupervised training, semi-supervised training back propagation, transfer learning, stochastic gradient descent, learning rate decay, dropout, max pooling, batch normalization, and/or any equivalent deep learning technique. In one or more aspects, one or more other components of the mixer 101 and/or other component of the audio system may implement one or more ML models to perform their respective functions.

In one or more exemplary embodiments, the personal mixing operations may include the adjustment of audio levels, panning, equalization (EQ), dynamic EQ, compression, multiband compression, summing, filtering, noise reduction, reverb, gain, delay, gating, expansion, de-essing, ducking, saturation, harmonic distortion, one or more modulation effects, sidechaining, adjustments to one or more other audio parameters, and/or one or more other audio processing operations.

Panning may include the process of placing audio elements in the stereo field, so that they appear to come from a particular location in the audio spectrum. For example, by adjusting the left-right balance of a signal, panning may create a sense of space and dimensionality in a mix. Equalization (EQ) may include the process of adjusting the frequency balance of audio tracks to improve balance and/or clarity. Equalization may include cutting or boosting specific frequency ranges to remove unwanted frequencies or enhance desired ones, and/or may be used to achieve a desired tone or timbre. Dynamic EQ may include adjusting the gain of certain frequency bands based on the input level of the audio signal, and may be useful in controlling harsh frequencies or taming certain resonances. Compression may include the process of reducing the dynamic range of audio tracks, making loud sounds quieter and quiet sounds louder. By reducing the difference between the loudest and softest parts of a track, compression may provide a more consistent and controlled audio. Multiband Compression is similar to compression, but instead of applying a single level reduction to the entire audio signal, it applies different levels of compression to different frequency bands. Multiband compression may be used to balance out a mix that has a lot of frequency imbalances. Summing may include adding together two or more audio signals to create a single output signal. The summing of audio signals may preserve the relative volume levels and stereo placement. Filtering may include the process of removing or attenuating certain frequencies in an audio signal, and may be used to remove unwanted noise and/or resonances, and/or to shape the tone of an audio signal. Noise reduction may include removing unwanted noise from an audio signal, such as removing hiss, hum, and/or other types of noise that may degrade the audio quality. Reverb may include simulating an acoustic environment in which an audio signal was recorded, and may be used to add space, depth, and/or natural reverberation to an audio signal, and/or to create a sense of continuity between different parts of a mix. Gain may include adjusting the overall level of an audio signal, and may be used to balance levels of different audio tracks in a mix, and/or to increase or decrease the overall loudness of the audio track. Delay adjustments may include the introduction of a time delay between an audio signal and its output, and/or the introduction of echoes and/or repeats. Delay may be used to create stereo width and/or to create rhythmic effects. Gating may include the attenuating of an audio signal when it falls below a certain level, and may be used to remove unwanted noise and/or in controlling the decay of certain sounds. Expansion may be the opposite of compression, where instead of reducing the dynamic range of an audio signal, expansion increases it. Expansion may be used to increase the life and energy to a mix. De-essing may include the process of reducing the level of harsh sibilant sounds in an audio signal, such as “s” and “t” sounds. De-essing may make a mix sound less harsh and more pleasant to listen to. Ducking may include the reduction of the level of one audio signal when another audio signal is present. This can be useful in making a mix sound more cohesive and reducing clashes between different tracks. Saturation may include adding harmonic distortion to an audio signal, which may be used add warmth and character to a mix. Harmonic Distortion may include adding distortion to an audio signal to create new harmonic content. Modulation Effects may include effects (e.g. chorus, flanger, and phaser) that modulate certain aspects of an audio signal, such as pitch, frequency, and/or amplitude. Side chaining may include using the level of one or more audio signals to control the processing of one or more other audio signals. A side chain input may be used, for example, on a compressor or other processor, which allows the level of the separate audio signal(s) to control the amount of processing applied to the other audio signal(s). For example, in a music mix, a side chain input can be used to trigger a compressor on a bass track using the kick drum track as the side chain input. This may cause the bass to be compressed every time the kick drum hits, which can help to create a more cohesive and tight rhythm section. In another example, side chaining may be used in other applications, such as where a music track can be automatically ducked (e.g. reduced in volume) whenever the voiceover is present to ensure that the voiceover remains clear and audible over the music.

In one or more exemplary embodiments, the personal mixing operations may additionally or alternatively include one or more advanced processing algorithms, such as one or more audio processing that uses machine learning (ML) to adjust mixing parameters and/or control the mixing operations of the mixer 101 (e.g., personal mixer 205). The advanced processing techniques may include spatialization, denoising, auto mixing, and/or one or more other advanced audio processing operations. Spatialization may create a sense of space and depth within an audio mix by, for example, placing different sounds in different locations within the stereo or surround sound field, creating a more immersive and realistic listening experience. Spatialization techniques may include panning, reverberation, and delay effects, as well as more advanced techniques like binaural and ambisonic processing. Denoising may include removing unwanted noise from an audio signal (e.g. drum bleed). Noise can come from a variety of sources, including background hum, hiss, and/or electronic interference. Denoising techniques may include spectral subtraction, noise gating, and/or adaptive filtering, as well as more advanced techniques like ML-based noise reduction algorithms. Denoising techniques may remove and/or attenuate unwanted noise while preserving the quality and clarity of the desired audio signal. Auto mixing may include one or more mixing operations that are at least partially automated (e.g. using ML). Auto mixing may include performing one or more audio processing operations to, for example, emphasize or deemphasize one or more channels.

The I/O interface 208 may be configured to receive one or more inputs that allow the mixer 101 to receive audio signals from different sources, such as microphones, instruments, and playback devices. The audio signals may be received on one or more channels. The I/O interface 208 may include one or more input connections configured to receive input data and/or signals using one or more wired and/or wireless communication protocols, and/or may include one or more input devices (e.g. keyboard, control panel, graphical user interface (GUI), human-machine interface, or the like). Additionally, or alternatively, the I/O interface 208 may include one or more output connections configured to transmit output data and/or signals using one or more wired and/or wireless communication protocols, and/or may include one or more output devices (e.g. speaker, display, GUI, etc.). The I/O interface 208 may include an audio interface (e.g., 3.5 mm connector; an audio-over-IP interface (such as interface(s) supporting the Real-time Transport Protocol (RTP), Dante, Audio Video Bridging (AVB), the Audio Engineering Society (AES) 67 protocol, Multichannel Audio Digital Interface (MADI) or other AES10-complient protocols, etc.); a general-purpose interface (e.g., a universal serial bus (USB) connector); an XLR connector; or any other type of interface. As shown in FIG. 2, the mixer 101 may be connected to the PSM transmitter 102 via a connection 111 established between the I/O interface 208 and the I/O interface 218 of the PSM transmitter 102. The connection 111 may use one or more wired and/or wireless communication protocols.

Inputs to the mixer 101 (e.g. via the I/O interface 208) may be any audio, electrical, and/or electromagnetic signals (e.g., originated from any input devices and/or sources, such as from the performer(s), instrument(s), audio track(s), etc.) that may be processed by the mixer 101. Outputs from the mixer 101 (e.g. via the I/O interface 208) may be any audio (e.g., mixed and/or processed audio), electrical, and/or electromagnetic signals that may be played back via output devices, stored, and/or processed by other devices. Input devices that may provide input to the mixer 101 may include one or more of: wireless microphones, wearable packs (e.g., bodypack, beltpack) associated with microphones, wireless headsets integrated with a microphone, electronically-readable memory comprising stored audio, a computing device (e.g., smartphone, tablet) with integrated microphones, and/or a transceiver associated with a musical instrument and/or other audio and/or data source(s). Output devices that may be connected to the mixer 101 may include the PSM transmitter 102, speakers, wearable packs (e.g., bodypack, beltpack) associated with headsets, a wireless headset, a user computing device, an electronically-readable memory, a transceiver associated with a musical instrument, an output interface (e.g., an XLR connector, USB connector, 3.5 mm connector, etc.), a server associated with a computing network (e.g., local network, public network such as the Internet), a computing device (e.g., smartphone, tablet) with integrated speakers or connected headphones, etc.

The controller 210 may be configured to control and/or monitor one or more other components of the audio system 100, and/or exchange data and/or information with one or more other components. The exchange of data and/or information with the other component(s) may include transmitting data and/or information to the other component(s) and/or receiving data and/or information from the other component(s). The receipt of data and/or information from the other component(s) may be in response to one or more requests for data and/or information from the mixer 101 (e.g., the controller 210). The controller 210 may establish one or more connections 245, 255 with the controllers of the other components using one or more wired and/or wireless communication protocols. For example, the controller 210 may establish a connection 245, 255 with controller 220 (e.g. via connection 245) of the PSM transmitter 102, and/or with controller 230 (e.g., via connection 255) of the PSM receiver 104. The connection(s) 245 between the controller 210 of mixer 101 and the controller 220 of the PSM transmitter 102 may be facilitated via the respective I/O interfaces 208, 218. Alternatively, or additionally, the controllers 210 and 220 may include integrated I/O interfaces and/or transceivers configured to facilitate wired and/or wireless communications without involving the I/O interfaces 208 and/or 218. According to one or more exemplary embodiments, the connections(s) 245, 255 (e.g., backchannel connection(s)) between the various controllers may be separate from the connection(s) 113 established between the PSM transmitter 102 and PSM receiver 104 to transmit audio signals to the PSM receiver 104. The connection(s) 245, 255 between the controllers 210, 220, 230 are represented in the drawings by the dashed bi-directional connections, while the (e.g., wireless) connection 113 between the PSM transmitter 102 and/or PSM receiver 104 is represented by a lightning bolt to illustrate the different connections. The connection(s) 245, 255 may function as backchannel connection(s)/communication link(s) separate from the connection(s) 113. As discussed herein, the connection(s) 245, 255 may use one or more wired and/or wireless communication protocols, which may include, for example, Shure Inc.'s ShowLink® communication protocol(s) and/or one or more other protocol(s) such as IEEE 802.15.4.

With continued reference to FIG. 2, according to one or more exemplary embodiments, the PSM transmitter 102 may include one or more of processor(s) 212, memory 214, transceiver(s) 216, input/output (I/O) interface(s) 208, and/or controller 220. One or more data buses may interconnect the processor(s) 212, the memory 214, transceiver(s) 216, I/O interface(s) 218, and/or controller 220. The PSM transmitter 102 may be implemented using one or more integrated circuits (ICs), software, or a combination thereof, configured to operate as described herein. The memory 214 may comprise any memory, such as RAM, ROM, a flash memory, or any other electronically readable memory, or the like. The memory 214 may include one or more memory units.

Signals transmitted from and/or received by the PSM transmitter 102 may be encoded in one or more data units. For example, the processor(s) 212 may be configured to generate data units, and process received data units, that conform to any suitable wired and/or wireless communication protocol. The processor(s) 212 may be configured to execute machine readable instructions stored in memory 214 to perform one or more operations described herein. The transceiver 216 may be configured to send/receive signals to/from PSM receiver(s) 104 using one or more communication protocols. For example, digital audio signals received by the PSM receiver(s) 104 may be audio signals contained in one or more radio frequency (RF) signals transmitted by the transceiver 216. The communication protocols may be any wired communication protocol(s), wireless communication protocol(s), and/or one or more protocols corresponding to one or more layers in the Open Systems Interconnection (OSI) model. For example, the transceiver 216 may be configured to transmit and/or receive signals using an IEEE 802.11 WIFI protocol, an IEEE 802.15.1 protocol (e.g., Bluetooth), an IEEE 802.15.4 protocol (e.g., Zigbee), or one or more other wireless personal area network (WPAN) protocols, a 3GPP cellular protocol, a LAN protocol, HTTP), FM radio, infrared, one or more optical protocols, fiber optics, ISM bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHz-61.5 GHz band, etc.), VHF band(s) (e.g., 30 MHz-300 MHz band) and/or via (e.g., one or more channels within) UHF band(s) (e.g., 300 MHz-3 GHz). The communication protocols that may be used are not limited to these example protocols. In one or more examples, and as further described herein with respect to FIGS. 1, 6, and 7, the PSM transmitter 102 may also communicate with one or more electronic devices 110 (e.g., smartphones, tablet computers, remote control devices, etc.) that may be configured to control operation of the PSM transmitter 102. The mixer 101 may be similarly configured to communicate with the electronic device(s) 110 via the PSM transmitter 102 and the connection(s) 111, 245 between the mixer 101 and PSM transmitter 102.

The processor(s) 212 may be configured to perform one or more operations of the PSM transmitter 102, including controlling the operation of the PSM transmitter 102 and/or operation of one or more of its other components. For example, the processor(s) 212 may process data and/or information received from the mixer 101, and/or control the transceiver 216 to perform transmission and/or reception operations. The processor(s) 212 may execute machine readable instructions stored in memory 2104 to perform one or more operations of the PSM transmitter 102. Signals received and/or output by the PSM transmitter 102 (e.g., via the transceiver 216 and/or I/O interface 218) may be encoded in one or more data units. For example, the processor(s) 212 may be configured to generate data units, and process received data units, that conform to any suitable wired and/or wireless communication protocol.

The I/O interface 218 may be configured to receive one or more inputs that allow the PSM transmitter 102 to receive audio signals from different sources, such as the mixer 101, microphones, instruments, and/or playback devices. The audio signals may be received on one or more channels. The I/O interface 218 may include one or more input connections configured to receive input data and/or signals using one or more wired and/or wireless communication protocols, and/or may include one or more input devices (e.g. keyboard, control panel, graphical user interface (GUI), human-machine interface, or the like). Additionally, or alternatively, the I/O interface 218 may include one or more output connections configured to transmit output data and/or signals using one or more wired and/or wireless communication protocols, and/or may include one or more output devices (e.g. speaker, display, GUI, etc.). The I/O interface 218 may include an audio interface (e.g., 3.5 mm connector; an audio-over-IP interface, such as interface(s) supporting Dante, Audio Video Bridging (AVB), the Audio Engineering Society (AES) 67protocol, Multichannel Audio Digital Interface (MADI) or other AES10-complient protocols, etc.), a general-purpose interface (e.g., a universal serial bus (USB) connector), an XLR connector, or any other type of interface. As shown in FIG. 2, the PSM transmitter 102 may be connected to the mixer 101 via connection 111 established between the I/O interface 218 and the I/O interface 208 of the mixer 101. The connection 111 may use one or more wired and/or wireless communication protocols.

Inputs to the PSM transmitter 102 (e.g. via the I/O interface 218 and/or transceiver 216) may be any data and/or information, audio signals, electrical signals, and/or electromagnetic signals. The inputs may originate from the mixer 101 as shown in FIG. 2, from any input devices and/or sources (e.g., from the performer(s), instrument(s), audio track(s), etc.), and/or from electronic device(s) 110. The inputs may be processed and/or transmitted by the PSM transmitter 102. Outputs from the PSM transmitter 102 (e.g. via the I/O interface 208 and/or transceiver 216) may be any data and/or information processed by the PSM transmitter 102, audio signals (e.g., mixed and/or processed audio from the mixer 101), electrical signals, and/or electromagnetic signals that may be played back via output devices, stored, and/or processed by other devices. Input devices that may provide input to the PSM transmitter 102 may include the mixer 101 or any other device configured to serve as an input to the mixer 101. Output devices that may be connected to the PSM transmitter 102 may include the PSM receiver(s) 104, electronic device(s) 110, speakers, wearable packs (e.g., beltpacks) associated with headsets, a wireless headset, a user computing device, an electronically-readable memory, a transceiver associated with a musical instrument, an output interface (e.g., an XLR connector, USB connector, 3.5 mm connector, etc.), a server associated with a computing network (e.g., local network, public network such as the Internet), a computing device (e.g., smartphone, tablet) with integrated speakers or connected headphones, etc.

The controller 220 may be configured to control and/or monitor one or more other components of the audio system 100, and/or exchange data and/or information with one or more other components. The exchange of data and/or information with the other component(s) may include transmitting data and/or information to the other component(s) and/or receiving data and/or information from the other component(s). The receipt of data and/or information from the other component(s) may be in response to one or more requests for data and/or information from the PSM transmitter 102 (e.g., the controller 220). The controller 220 may establish one or more connections 245, 255 with the controllers of the other components using one or more wired and/or wireless communication protocols. For example, the controller 220 may establish a connection 245, 255 with controller 210 (e.g. via connection 245) of the mixer 101, and/or with controller 230 (e.g., via connection 255) of the PSM receiver 104. The connection(s) 245 between the controller 210 of mixer 101 and the controller 220 of the PSM transmitter 102 may be facilitated via the respective I/O interfaces 208, 218. Alternatively, or additionally, the controllers 210 and 220 may include integrated I/O interfaces and/or transceivers configured to facilitate wired and/or wireless communications without involving the I/O interfaces 108 and/or 218. The connection(s) 255 between the controller 220 of PSM transmitter and the controller 230 of the PSM receiver 104 may be facilitated via the respective transceivers 216, 226. Alternatively, or additionally, the controllers 220 and 230 may include integrated I/O interfaces and/or transceivers configured to facilitate wired and/or wireless communications without involving the transceivers 216, 226 and/or I/O interfaces 218 and/or 228. Again, according to one or more exemplary embodiments, the connections(s) 245, 255 between the various controllers may be separate from the connection(s) 113 established between the PSM transmitter 102 and PSM receiver 104 to transmit audio signals and/or other data/information to the PSM receiver 104 and/or to one or more other devices.

With continued reference to FIG. 2, in an exemplary embodiment, the PSM receiver 104 may include one or more of processor(s) 222, memory 224, transceiver(s) 226, I/O interface(s) 228, and/or controller 230. One or more data buses may interconnect the processor(s) 222, the memory 224, transceiver(s) 226, I/O interface(s) 228, and/or controller 230. The PSM receiver 104 may be implemented using one or more ICs, software, or a combination thereof, configured to operate as described herein. The memory 224 may comprise any memory, such as RAM, ROM, a flash memory, or any other electronically readable memory, or the like. The memory 224 may include one or more memory units.

The PSM receiver 104 may receive one or more data units from the PSM transmitter 102 using the transceiver 226. The transceiver 226 may be configured to receive/send signals from/to the PSM transmitter 102 using one or more communication protocols, such as those usable by the PSM transmitter 102 and discussed above. For example, the transceiver 216 may be configured to transmit and/or receive signals using an IEEE 802.11 WIFI protocol, an IEEE 802.15.1 protocol (e.g., Bluetooth), an IEEE 802.15.4 protocol (e.g., Zigbee), or one or more other wireless personal area network (WPAN) protocols, a 3GPP cellular protocol, a LAN protocol, HTTP), FM radio, infrared, one or more optical protocols, fiber optics, ISM bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHZ-61.5 GHz band, etc.), VHF band(s) (e.g., 30 MHz-300 MHz band) and/or via (e.g., one or more channels within) UHF band(s) (e.g., 300 MHz-3 GHz). The communication protocols that may be used are not limited to these example protocols. In one or more examples, and as further described herein with respect to FIGS. 1, 6, and 7, the PSM receiver 104 may also communicate with one or more electronic devices 110 (e.g., smartphones, tablet computers, remote control devices, etc.) that may be configured to control operation of the PSM receiver 104.

The processor(s) 222 may be configured to perform one or more operations of the PSM receiver 104, including controlling the operation of the PSM receiver 104 and/or operation of one or more of its other components. For example, the processor(s) 222 may process data and/or information received from the PSM transmitter 102, and/or control the transceiver 226 to perform transmission and/or reception operations. The processor 222 may decode the data unit(s) received by the PSM receiver 104 to generate one or more audio signals. The processor(s) 222 may be configured to execute machine readable instructions stored in memory 224 to perform one or more operations of the PSM receiver 104.

The audio signals generated by the PSM receiver 104 may be provided to the performer associated with the PSM receiver 104 to provide the performer with monitoring feedback. This feedback allows performers to hear themselves, instruments, audio tracks, and/or other performers more clearly. The I/O interface 228 may be configured similarly as the I/O interface 218, and include one or more input connections configured to receive input data and/or signals using one or more wired and/or wireless communication protocols, and/or may include one or more input devices (e.g. keyboard, control panel, graphical user interface (GUI), human-machine interface, or the like). Additionally, or alternatively, the I/O interface 228 may include one or more output connections configured to transmit output data and/or signals using one or more wired and/or wireless communication protocols, and/or may include one or more output devices (e.g. speaker, display, GUI, etc.). The I/O interface 228 may include an audio interface (e.g., 3.5 mm connector; an audio-over-IP interface, such as interface(s) supporting Dante, Audio Video Bridging (AVB), the Audio Engineering Society (AES) 67 protocol, Multichannel Audio Digital Interface (MADI) or other AES10-complient protocols, etc.), a general-purpose interface (e.g., a universal serial bus (USB) connector), an XLR connector, or any other type of interface. Outputs from the PSM receiver 104 may be any data, information; and/or audio signals, electrical signals, and/or electromagnetic signals that may be played back via output devices, stored, and/or processed by other devices.

The controller 230 may be configured to monitor and/or control one or more other components (e.g., mixer 101, PSM transmitter 102) of the audio system 100, and/or exchange data and/or information with one or more other components. For example, the user associated with the PSM receiver 104 may adjust audio levels, EQ, and/or other parameters via the I/O interface 228, and commands representing the requested adjustments may be provided to the PSM transmitter 102 and/or mixer 101 to control the PSM transmitter 102 and/or mixer 101 to perform the adjustments. This allows for the user to further customize their monitor mix to suit their individual preferences and needs.

The controller 230 may establish one or more connections 245, 255 with the controllers of the other components using one or more wired and/or wireless communication protocols. For example, the controller 230 may establish a connection 255 with controller 220 of the PSM transmitter 102 and/or with controller 210 (e.g. via connection 245) of the mixer 101. The connection(s) 245 between the controller 210 of mixer 101 and the controller 230 of the PSM receiver 104 may be facilitated via the respective I/O interfaces 208, 218. Alternatively, or additionally, the controllers 210 and 230 may include integrated I/O interfaces and/or transceivers configured to facilitate wired and/or wireless communications without involving the I/O interfaces 108 and/or 218. Alternatively, or additionally, the controller 230, using transceiver 226, may configured to facilitate wired and/or wireless communications with an integrated transceivers of the controller 210. The connection(s) 255 between the controller 220 of PSM transmitter and the controller 230 of the PSM receiver 104 may be facilitated via the respective transceivers 216, 226. Alternatively, or additionally, the controllers 220 and 230 may include integrated I/O interfaces and/or transceivers configured to facilitate wired and/or wireless communications without involving the transceivers 216, 226 and/or I/O interfaces 218 and/or 228. Again, according to one or more exemplary embodiments, the connections(s) 245, 255 between the various controllers may be separate from the connection(s) 113 established between the PSM transmitter 102 and PSM receiver 104 to transmit audio signals and/or other data/information to the PSM receiver 104 and/or to one or more other devices.

The controller 230 may be configured to control and/or monitor one or more components of the mixer 101 (e.g., personal mixer 205), such as to monitor statuses of the mixer 101 and/or adjust one or more mixing operations of the mixer 101, and/or one or more components of the PSM transmitter 102 (e.g., transceiver 216, processor 212, etc.). The control of the component(s) of the audio system 100 (and sub-components therein) may include monitoring the statuses of the operation of the components (and sub-components) and/or adjusting the operation of the components (and sub-components). For example, the controller 230 (and/or controllers 210, 220) may be configured to monitor one or more audio and/or mixing settings and/or adjust one or more audio and/or mixing settings. The audio and/or mixing settings may include, for example, gain, such as the main mix coming from the mixer 101, individual gain (e.g., gain associated with a sub channel), frequency, EQ, power levels, volume limits, volume lock, gain trim, and/or other audio and/or mixing settings. For example, the controller 230 may monitor the RF power of the signal(s) received from the PSM transmitter 102, and based on the RF power level, generate and provide a command to controller 220 of the PSM transmitter 102 to control the PSM transmitter 102 to adjust (e.g., increase) the RF power level. As another example, the controller 210, 220, 230 may monitor a power level and/or power mode of one or more other components and control the component(s) to adjust the power mode of the component(s). For example, the PSM receiver 104 may be battery powered, and the power level (e.g., remaining runtime) may be monitored by the controller 210 and/or controller 220. If the power level is less than a power level threshold, the controller 210 and/or controller 220 may be command the controller 230 to cause the PSM receiver 104 to adjust the power mode (e.g., low power mode, normal power mode, performance power mode) of the PSM receiver 104, such as to enter a low-power mode to reduce the power consumption of the PSM receiver 104 to extend the runtime of the PSM receiver 104. As another example, based on the monitored power level, the PSM transmitter and the PSM receiver 104 may be controlled to reduce the number of RF channels being used to facilitate the exchange of audio data.

The exchange of data and/or information (e.g., statuses, etc.) with the other component(s) may include transmitting data and/or information to the other component(s) and/or receiving data and/or information from the other component(s). The exchange of data and/or information may include device parameters, such as a current operating state, power state, power mode (e.g., low power mode, normal power mode, performance power mode), battery level, frequency, audio settings (e.g., EQ, volume limits, volume lock, gain trim, and/or other audio or mixing settings), parameters of connected device(s), and/or other data and/or information associated with the other components. The receipt of data and/or information from the other component(s) may be in response to one or more requests for data and/or information from the PSM receiver 104 (e.g., the controller 230).

Other devices in the audio system (e.g., amplifiers, speakers, musical instruments, general-purpose computing devices, etc.) may have an architecture similar to the mixer 101, PSM transmitter 102, and/or PSM receiver 104. For example, one or more of the other devices in the audio system may comprise corresponding memories, processors, transceivers, mixers or other audio processors, I/O interfaces, and/or controllers. In an exemplary embodiment, one or more components of the mixer 101, PSM transmitter 102, and/or the PSM receiver 104 may include processing circuitry (e.g. one or more processors and/or circuitry) that is configured to perform the respective functions and/or operations of the component(s).

The audio system 100 of FIG. 2 may be implemented with one or more other audio subcomponents, and the audio system 100 may include a complex configuration of interconnected discrete subcomponents, such as receivers, mixers, amplifiers, and PSM systems, resulting in a system having a large overall footprint. These audio systems may require careful consideration of compatibility between the devices and may result in added complexity (e.g. complex set-up, use, dismantle, and/or troubleshooting) due to the use of the multiple wired connections/adapters to connect the devices. In addition to the increased complexity, the various interconnections may introduce unwanted noise (e.g. switching noise and/or coupling) and/or latency, as well as being susceptible to equipment failures (e.g. cable breakage and disconnects).

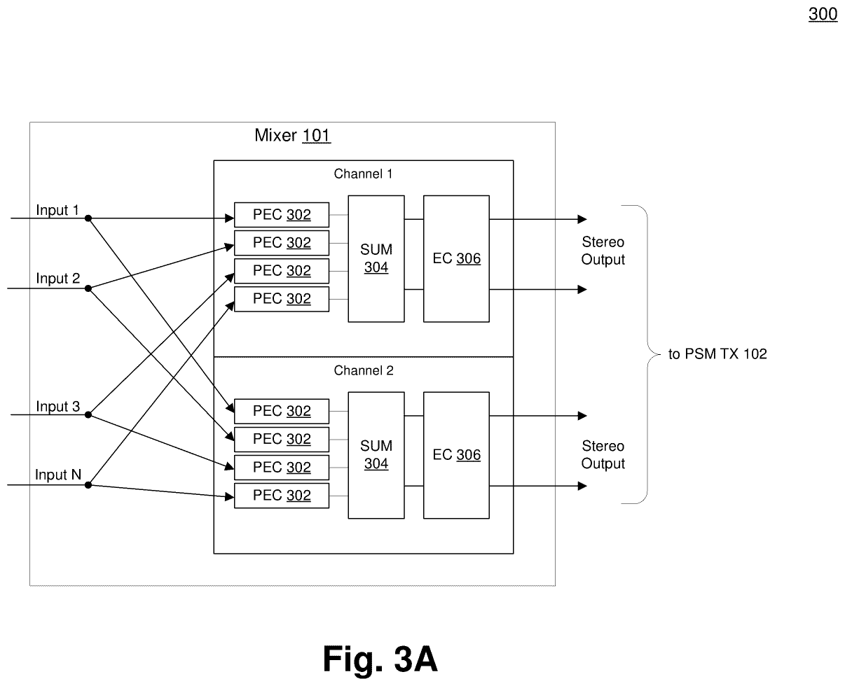

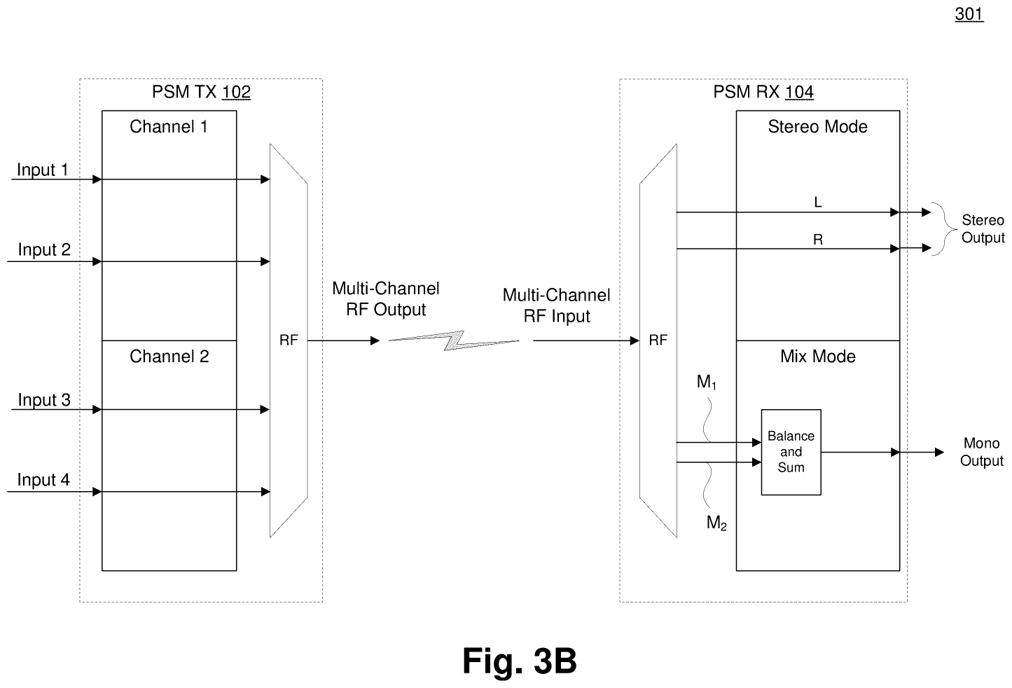

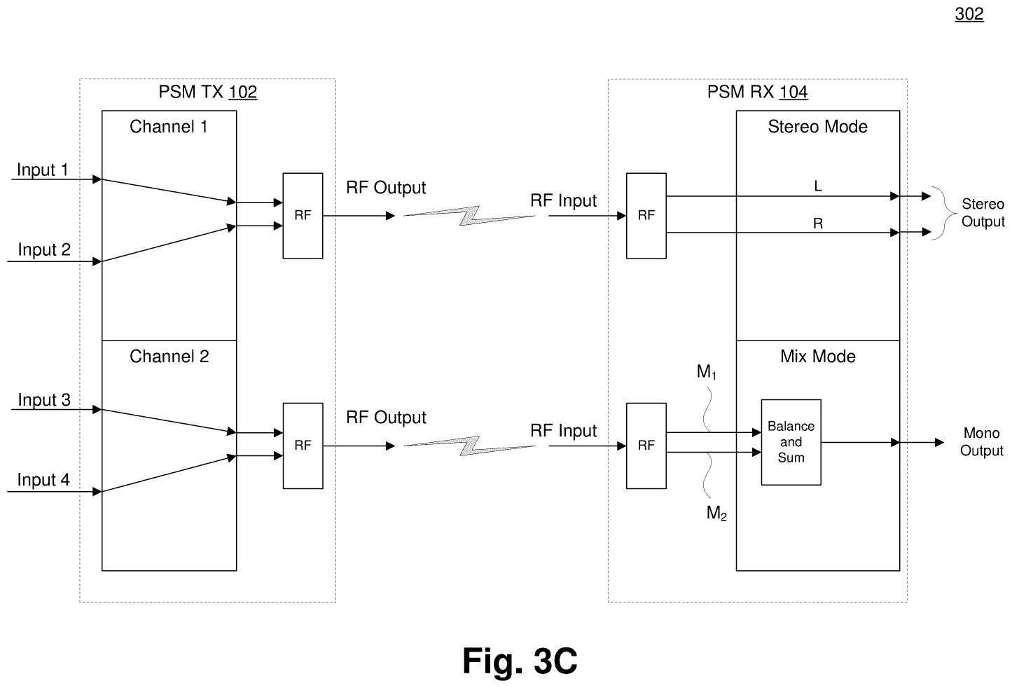

FIGS. 3A-3C illustrate example operations 300-302 of audio system 200 according to one or more exemplary embodiments. With reference to FIG. 3A, the mixer 101 may receive one or more inputs on one or more channels. In the illustrated example, the mixer 101 is configured to accept inputs on two channels, but is not limited thereto. The first and/or second channels may be configured to receive four audio input signals (input 1, input 2, input 3, . . . input N). In other aspects, the inputs of the channels may include less or more audio input signals. In an exemplary embodiment, the input signals are received by the mixer 101 via the I/O interface 208. In this example, the audio input signals may include audio inputs from different sources, which are mixed down to two-channel outputs. Here, each channel output is a stereo output. For example, channel 1 may provide a stereo output corresponding to a first audio mix and channel 2 may provide a stereo output corresponding to a second audio mix different from the first audio mix.

In an exemplary embodiment, one or more of the channel outputs may alternatively include two mono outputs instead of a single stereo output (e.g., see FIGS. 3B and 3C), where the individual mono input signals represent a different audio mix. For example, channel 1 may provide a stereo output corresponding to a particular audio mix, while channel 2 provides two different mono outputs corresponding to two different mono audio mixes. In this example, the mixer 101 would then provide three different audio mixes (e.g., one stereo mix (channel 1), a first mono mix (channel 2) and a second mono mix (channel 2)).

In an exemplary embodiment, the audio input signals may correspond to a surround audio signal that includes the (e.g., four) audio input signals instead inputs from different sources. In an exemplary embodiment, a subset of the audio input signals may correspond to a surround audio signal while another subset of the audio input signals may include audio inputs from different sources.

The audio input signals may be processed by the personal mixer 205. In the illustrated example, the personal mixer 205 may perform a combination of equalization (EQ), panning, compression, and summing on the input audio signals. Additionally, or alternatively, the personal mixer 205 may perform one or more other mixing operations. In an exemplary embodiment, the personal mixer 205 may include a mixing/processing pipeline that includes two or more mixing stages. The individual mixing stages may include one or more mixing operations, which may be performed sequentially or at least partially simultaneously. In an exemplary embodiment, the mixing/processing pipeline may include three mixing stages. The first mixing stage may include panning, equalizing, and/or compression of the respective audio input signals, which generates a first intermediate mixed signal for the respective audio input streams. The first mixing stage may be performed by a panning, equalizing, and compressing (PEC) processor 302 of the personal mixer 205. In an exemplary embodiment, the personal mixer 205 may include respective PEC processors 302 for each of the audio input signals, but is not limited thereto. The resulting four intermediate signals may then be provided to the second mixing stage, which may be configured to sum the four intermediate signals to generate intermediate stereo signals. The summing operation may be performed by a summing processor 304 of the personal mixer 205. The intermediate stereo signal may then be provided to the third mixing stage that includes equalizing and/or compressing of the intermediate stereo signals to generate a mixed stereo output signal. The equalization and/or compression of the intermediate stereo signals may be performed by an equalizing and compression processor 306 of the personal mixer 205. The mixed stereo output signals may include a left (L) audio signal and a right (R) audio signal. The mixed stereo output signals may be outputted via the I/O interface 208. The PSM transmitter 102 may receive the mixed stereo output signal via the connection 111 established between the I/O interface 208 and the/O interface 218 of the PSM transmitter 102. In one or more aspects, the mixed output signals may include less (e.g. mono) or more audio input signals (e.g. surround).

As illustrated in FIG. 3B, the PSM transmitter 102 may receive one or more inputs on one or more channels (e.g., the mixed stereo output signals from the mixer 101 (FIG. 3A) and/or one or more mono outputs from the mixer 101 and/or other audio source(s)). In the illustrated example, the PSM transmitter 102 is configured to accept inputs on two channels, but is not limited thereto. The first and/or second channels may be configured to receive a stereo audio signal (that includes a left (L) audio input signal and a right (R) audio input signal) and/or one or more mono audio signals. In other aspects, the inputs of the channels may include less (e.g. mono) or more audio input signals (e.g. surround). In an exemplary embodiment, the input signals are received by the PSM transmitter 102 via the I/O interface 218. In the illustrated example, as described in more detail below, inputs 1 and 2 may collectively correspond to a stereo audio input, while inputs 3 and 4 may correspond to respective mono audio inputs, which may correspond to unique mono audio mixes.

On the first and/or second channels, the stereo audio input signals are modulated (e.g., by a radio-frequency (RF) module, such as an RF front end) to generate a multi-channel radio-frequency (RF) output signal. For example, the transceiver 206 may modulate the audio input signals onto a carrier wave to generate the RF output signal. The transceiver 216 may then transmit the RF output signal to the PSM receiver 104. As shown in FIG. 3C, instead of the multi-channel RF implementation shown in FIG. 3B, the PSM transmitter 102 and the PSM receiver 104 may include respective RF modules for each of the audio channels.

The PSM receiver 104 receives the RF output signal(s) from the PSM transmitter 102. For example, the transceiver 226 of the PSM receiver 104 may down-convert the received RF signal(s) to generate output monitor signals. In the illustrated example, the RF output signal may be converted to provide a stereo monitoring signal for the first channel. On the second channel, the multi-channel RF signal (or respective RF signal as shown in FIG. 3C) may be converted to provide one or more mono input signals M₁, M₂. In this example, the PSM receiver 104 may balance and sum the mono input signals M₁, M₂ to generate a mono monitoring signal. The balancing and summing may include the selection of one of the mono input signals M₁, M₂ as the mono monitoring signal. In this example, PSM receiver 104 may operate in a “mix mode” and the user may select which one of the two mono mixes to listen to. In the mix mode, the output may provide the selected mono monitoring signal in both cars. Another user (using a different PSM receiver 104) may select the other mono mix for their PSM receiver 104. This advantageously allows a single channel to be used for two independent mixes and users.

In an exemplary embodiment, the first mono monitoring signal M₁ may correspond to a first audio mix (e.g., of multiple sources, such as of the band) while the other mono monitoring signal M₂ may correspond to a particular user (e.g., lead singer). The user may then operate their PSM receiver 104 in the “mix mode” to locally mix the two monitoring signals M₁, M₂ to provide a mono mix of their vocals along with the mixed band feed.

FIG. 4A illustrates an audio system 400 according to one or more exemplary embodiments in which the PSM transmitter 102 further includes the mixer 101 to form PSM transmitter 402 having personal mixing functionality. For example, the PSM transmitter 402 may be configured to perform one or more audio mixing operations, digital signal processing (DSP), and/or other signal processing on the audio signals received (e.g. via I/O interface 208) to generate processed audio data. The processed audio data provides a customized mix of audio signals, which may then be transmitted to the PSM receiver 104 using the transceiver 206. FIG. 4B illustrates an audio system 450 according to one or more exemplary embodiments in which the mixer 101 further includes PSM transmitter 102 to form mixer 402 having one or more transceivers configured to facilitate wired and/or wireless communications so as to allow for the mixer 401 to communicate with the PSM receiver 104 using one or more wireless and/or wired communication protocols. The PSM transmitter 402 and the mixer 401 may be configured to perform one or more audio mixing operations, digital signal processing (DSP), and/or other signal processing on the audio signals received (e.g. via I/O interface 208, 218) to generate processed audio data. The processed audio data provides a customized mix of audio signals, which may then be transmitted to the PSM receiver 104 using one or more transceivers 216.

The integration of the mixer 101 within the PSM transmitter 102 to form PSM transmitter 402 (FIG. 4A) or the integration of the PSM transmitter 102 with the mixer 101 to form mixer 401 (FIG. 4B) provides an audio device with both personal mixing and transceiving functionality, and which is configured to tailor the feedback provided to the PSM receiver 104, while advantageously reducing the complexity and/or size of the overall audio system (e.g. by reducing the number of discrete components making up the audio system and reducing required intercommunions) and/or improving audio quality and performance by reducing noise (e.g. electrical switching noise and/or coupling) and/or latency of the audio system. Further, the integration provides the additional advantage of common temperature, process, and voltage conditions for the personal mixer 205, processor 202/212, memory 204/214, I/O interfaces 208/218, and transceiver 216. These common conditions may allow for increased performance and efficiency in compensating the effects of these conditions on the performance of the devices.

Although one or more aspects are described with the integration of the PSM transmitter 102 and mixer 101, the PSM receiver 104 may additionally or alternatively include a personal mixing device in one or more embodiments. For example, the PSM receiver 104 may include built-in limiters, EQ presets, and noise reduction, which can help to improve the overall sound quality and protect the performer's hearing.

In an exemplary embodiment, the processor(s) 202, 212 of the PSM transmitter 402 (FIG. 4A) or mixer 401 may be configured to control the mixing operations performed by the personal mixer 205 (of mixer 101) and/or the transmitting and receiving operations of the transceiver 216 (of PSM transmitter 102). The processor(s) 202, 212 may control and/or adjust the personal mixer 205 based on one or more received signals (e.g., via the I/O interface 208, 218 and/or transceiver 216/PSM transmitter 102, such as control signals (e.g., commands) received by the controllers 210, 220. As shown in FIGS. 4A-4B, the PSM transmitter 402 and mixer 401 may include one or more of the controllers 210, 220 of the mixer 101 and PSM transmitter 102, as discussed above. For example, the PSM transmitter 402 may include controller 220 (as discussed above with respect to PSM transmitter 102) and/or the mixer 101 integrated into the PSM transmitter 102 (forming PSM transmitter 402) may include its controller 210 (as discussed above with respect to mixer 101.

In an exemplary embodiment, the PSM transmitter 402 may include controller 220 and/or controller 210 (within the mixer 101). The controller 220 may be configured to monitor and/or control of one or more other components (e.g., PSM receiver 104) of the audio system 400 (e.g., using one or more commands), provide data, statuses, and/or other information to the other component(s), and/or receive data, statuses, and/or other information from the other component(s), which may include requesting data, statuses, and/or other information from the other component(s). Data signals may be transmitted and/or received between the PSM transmitter 402, PSM receiver(s) 104, electronic device 110, and/or other components of the audio system 400.

The information contained in the data signal may include commands, statuses, and/or other information sent and received from the components of the audio system 400 for monitoring and control purposes. For example, the controllers 220 and/or controller 210 (of mixer 101) may establish one or more connections 255 with the controller 230 of the PSM receiver 104 using one or more wired and/or wireless communication protocols. As similarly discussed with reference to FIG. 2, the connection(s) 255 between the controller 230 of PSM receiver 104 and the controller 220 and/or controller 210 may be facilitated via the respective transceivers 216, 226. Alternatively, or additionally, the controllers 210, 220, and/or 230 may include integrated I/O interfaces and/or transceivers configured to facilitate wired and/or wireless communications without involving the transceivers 216, 226 and/or I/O interfaces 218 and/or 228. Again, according to one or more exemplary embodiments, the connections(s) 255 between the various controllers may be separate from the connection(s) 113 established between the transceiver 216 of the PSM transmitter 402 and the transceiver 226 of the PSM receiver 104 to facilitate the transmission of audio signals and/or other data/information between the PSM transmitter 402 and the PSM receiver 104 (and/or to one or more other devices). The connections 113 and 255 may use the same or different communication protocols.

As shown in FIG. 4B, in an exemplary embodiment, the mixer 401 may include controller 210 and/or controller 220 (within the PSM transmitter 102). The controller 210 may be configured to monitor and/or control of one or more other components (e.g., PSM receiver 104) of the audio system 450 (e.g., using one or more commands), provide data, statuses, and/or other information to the other component(s), and/or receive data, statuses, and/or other information from the other component(s), which may include requesting data, statuses, and/or other information from the other component(s). Data signals may be transmitted and/or received between the mixer 401, PSM receiver(s) 104, electronic device 110, and/or other components of the audio system 450.

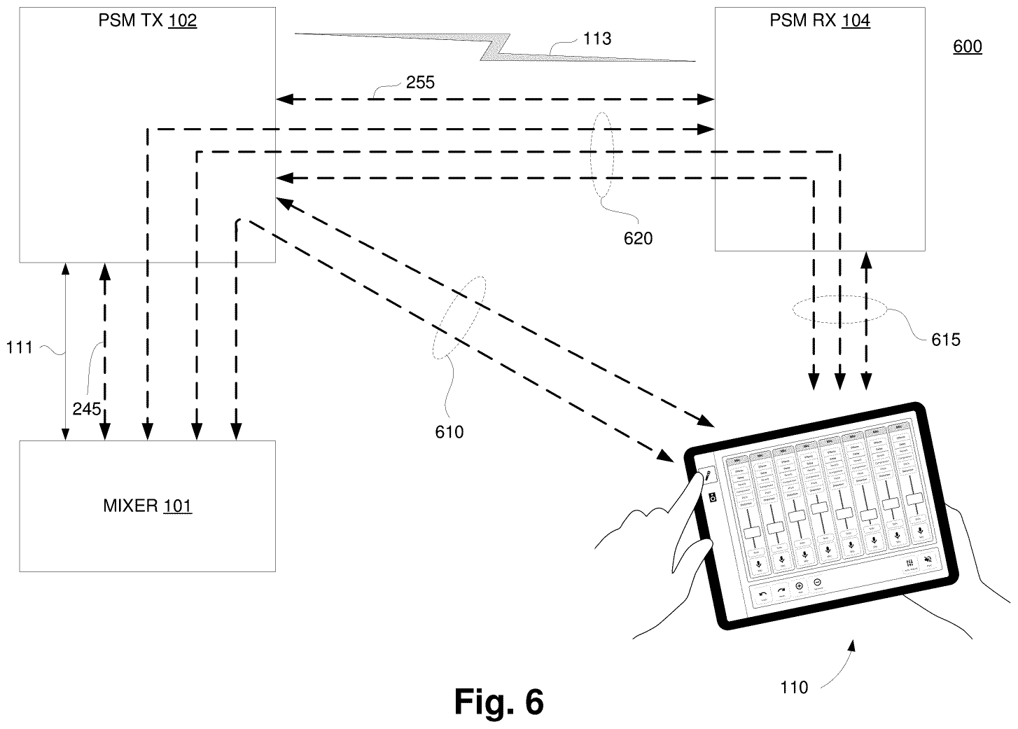

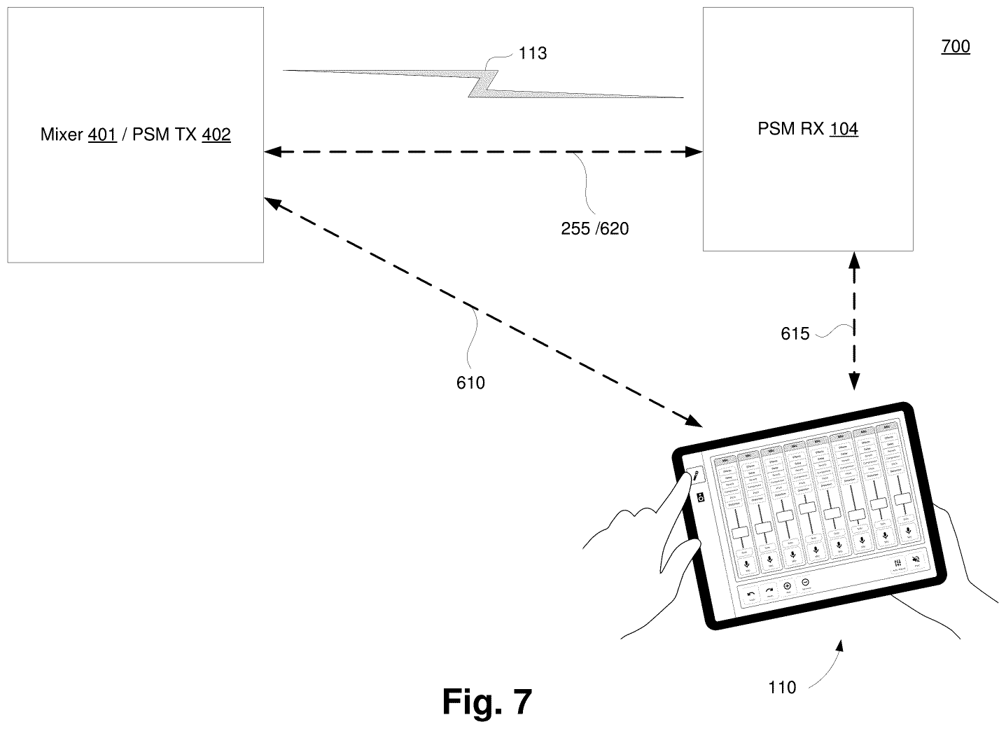

Again, the information contained in the data signal may include commands, statuses, and/or other information sent and received from the components of the audio system 450 for monitoring and control purposes. For example, the controllers 210 and/or controller 220 (PSM Tx 402) may establish one or more connections 255 with the controller 230 of the PSM receiver 104 using one or more wired and/or wireless communication protocols. As similarly discussed with reference to FIG. 2, the connection(s) 255 between the controller 230 of PSM receiver 104 and the controller 220 and/or controller 210 may be facilitated via the respective transceivers 216, 226. Alternatively, or additionally, the controllers 210, 220, and/or 230 may include integrated I/O interfaces and/or transceivers configured to facilitate wired and/or wireless communications without involving the transceivers 216, 226 and/or I/O interfaces 218 and/or 228. Again, according to one or more exemplary embodiments, the connections(s) 255 between the various controllers may be separate from the connection(s) 113 established between the transceiver 216 and the transceiver 226 to facilitate the transmission of audio signals and/or other data/information between the mixer 401 and the PSM receiver 104 (and/or to one or more other devices). As discussed in more detail below with reference to FIGS. 6-7, the controllers 210, 220, and/or 230 may additionally, or alternatively, be configured to transmit data, statuses, and/or other information to electronic device 110, and/or receive data, statuses, and/or other information from the electronic device 110.

The data signals (e.g., commands, statuses, and/or other information) may additionally or alternatively be communicated between the PSM receiver 104 and the PSM transmitter 402 (FIG. 4A) and/or mixer 401 (FIG. 4B) via the I/O interfaces 228 and 208, 228. Additionally, or alternatively, the data signals may be transmitted to and/or received from one or more other components of the audio system, one or more user devices (e.g. electronic device 110), inputs from a sound engineer, etc.

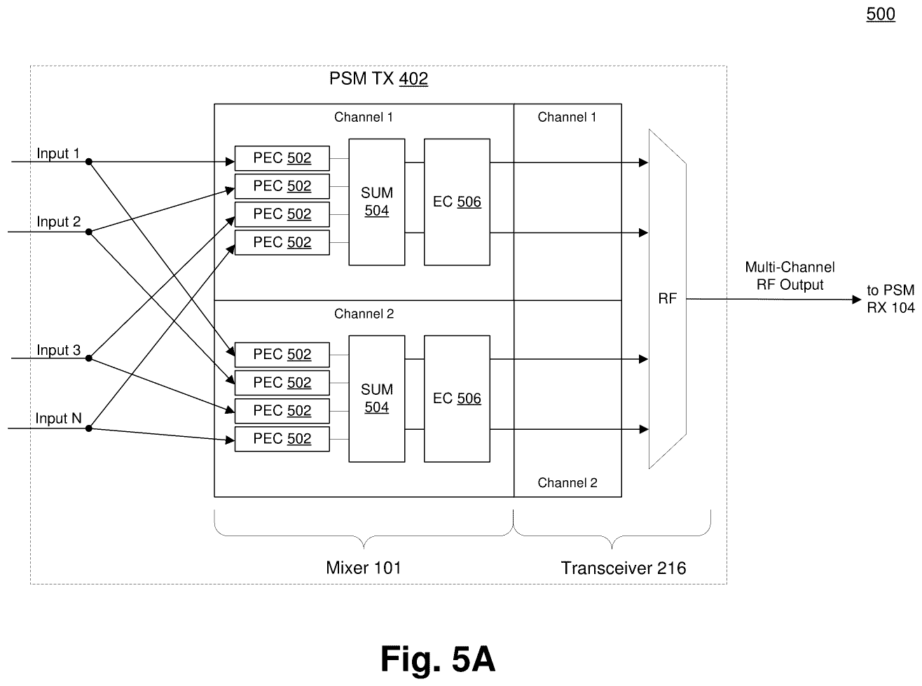

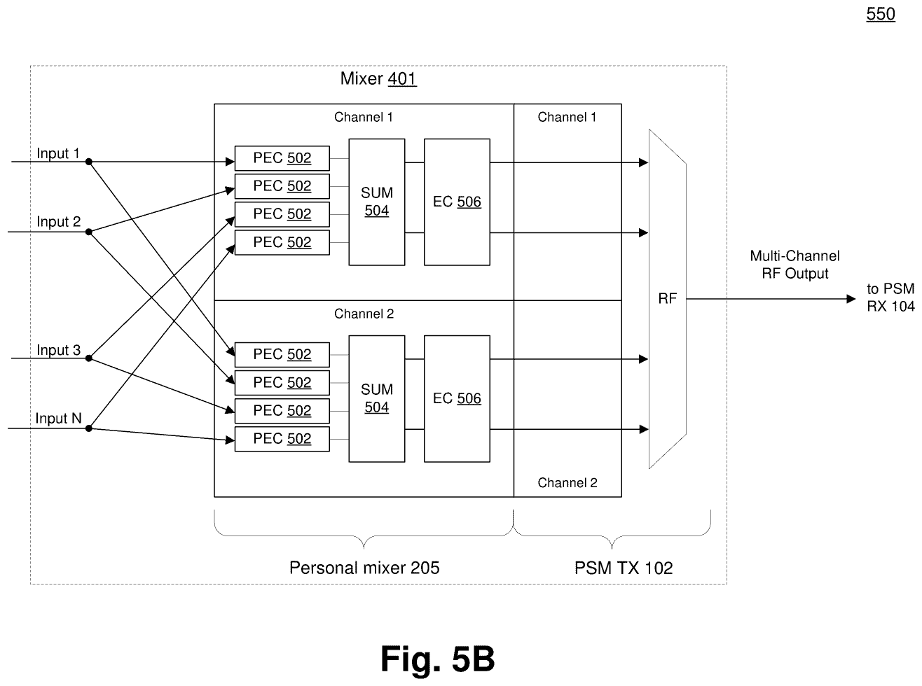

FIG. 5A illustrates an example operation 500 of audio system 400 according to one or more exemplary embodiments. The PSM transmitter 402 may receive one or more inputs on one or more channels. In the illustrated example, the PSM transmitter 402 is configured to accept inputs on two channels, but is not limited thereto. The first and/or second channels may be configured to receive a surround audio signal that includes four audio input signals. In other aspects, the inputs of the channels may include less or more audio input signals. In an exemplary embodiment, the input signals are received by the PSM transmitter 402 via the I/O interface 218.

The audio input signals may be processed by the mixer 101. In the illustrated example, the mixer 101 may perform a combination of equalization (EQ), panning, compression, and summing on the input audio signals. Additionally, or alternatively, the mixer 101 may perform one or more other mixing operations. In an exemplary embodiment, the mixer 101 may include a mixing/processing pipeline that includes two or more mixing stages. The individual mixing stages may include one or more mixing operations, which may be performed sequentially or at least partially simultaneously. In an exemplary embodiment, the mixing/processing pipeline may include three mixing stages. The first mixing stage may include panning, equalizing, and/or compression of the respective audio input signals, which generates a first intermediate mixed signal for the respective audio input streams. The first mixing stage may be performed by a panning, equalizing, and compressing (PEC) processor 502 of the mixer 101. In an exemplary embodiment, the mixer 101 may include respective PEC processors 502 for each of the audio input signals, but is not limited thereto. The resulting four intermediate signals may then be provided to the second mixing stage, which may be configured to sum the four intermediate signals to generate intermediate stereo signals. The summing operation may be performed by a summing processor 504 of the mixer 101. The intermediate stereo signal may then be provided to the third mixing stage that includes equalizing and/or compressing of the intermediate stereo signals to generate a mixed stereo output signal. The equalization and/or compression of the intermediate stereo signals may be performed by an equalizing and compression processor 506 of the mixer 101.

On the first and/or second channels, the mixed stereo output signals may be modulated to generate a multi-channel stereo RF output signal. For example, the transceiver 216 may modulate the stereo audio input signals onto a carrier wave to generate the RF output signal. The transceiver 216 may then transmit the RF output signal to the PSM receiver 104. Similar to the operation illustrated in FIG. 3B, the PSM receiver 104 may receive the RF output signal from the PSM transmitter 102. In an exemplary embodiment, the transceiver 216 may include respective RF modules for each of the channels similar to the configuration as shown in FIG. 3C instead of transmitting a multi-channel RF signal.

FIG. 5B illustrates an example operation 550 of audio system 450 according to one or more exemplary embodiments. The mixer 401 may receive one or more inputs on one or more channels. In the illustrated example, the mixer 401 is configured to accept inputs on two channels, but is not limited thereto. The first and/or second channels may be configured to receive a surround audio signal that includes four audio input signals. In other aspects, the inputs of the channels may include less or more audio input signals. In an exemplary embodiment, the input signals arc received by the mixer 401 via the I/O interface 208.

The audio input signals may be processed by the mixer 401. In the illustrated example, the mixer 401 may perform a combination of equalization (EQ), panning, compression, and summing on the input audio signals. Additionally, or alternatively, the mixer 401 may perform one or more other mixing operations. In an exemplary embodiment, the mixer 401 may include a mixing/processing pipeline that includes two or more mixing stages. The individual mixing stages may include one or more mixing operations, which may be performed sequentially or at least partially simultaneously. In an exemplary embodiment, the mixing/processing pipeline may include three mixing stages. The first mixing stage may include panning, equalizing, and/or compression of the respective audio input signals, which generates a first intermediate mixed signal for the respective audio input streams. The first mixing stage may be performed by a panning, equalizing, and compressing (PEC) processor 502 of the mixer 401. In an exemplary embodiment, the mixer 401 may include respective PEC processors 502 for each of the audio input signals, but is not limited thereto. The resulting four intermediate signals may then be provided to the second mixing stage, which may be configured to sum the four intermediate signals to generate intermediate stereo signals. The summing operation may be performed by a summing processor 504 of the mixer 401. The intermediate stereo signal may then be provided to the third mixing stage that includes equalizing and/or compressing of the intermediate stereo signals to generate a mixed stereo output signal. The equalization and/or compression of the intermediate stereo signals may be performed by an equalizing and compression processor 506 of the mixer 401

On the first and/or second channels, the mixed stereo output signals may be modulated to generate multi-channel stereo RF output signal. For example, the transceiver 216 of the PSM transmitter 102 may modulate the stereo audio input signals onto a carrier wave to generate the RF output signal. The transceiver 216 may then transmit the RF output signal to the PSM receiver 104. Similar to the operation illustrated in FIG. 3B, the PSM receiver 104 may receive the RF output signal from the mixer 401 (via the included PSM transmitter 102). In an exemplary embodiment, the PSM transmitter 102 may include respective RF modules for each of the channels similar to the configuration as shown in FIG. 3C instead of transmitting a multi-channel RF signal.

FIG. 6 illustrates an audio system 600 according to one or more exemplary embodiments. The audio system 600 may include mixer 101, PSM transmitter 102, PSM receiver 104, and one or more electronic devices 110 (e.g., user devices). The electronic device 110 may be configured to communicate with the components of the system 600 to externally control, for example, the mixer 101 (via the PSM transmitter 102 and/or PSM receiver 104 using connections 610, 620), the PSM transmitter 102 (via a direct connection 610 and/or indirectly via the PSM receiver 104 using connection 615), and/or the PSM receiver 104 (via connection 615). The controller 210 of the mixer 101, the controller 220 of the PSM transmitter 102, and/or the controller 230 of the PSM receiver 104 may be configured to transmit data, statuses, and/or other information to electronic device 110, and/or receive data, statuses, and/or other information from the electronic device 110. The exchange of such data, statuses, and/or other information may facilitate the monitoring and/or control of the mixer 101, PSM transmitter 102, and/or PSM receiver 104 by the electronic device(s) 110. The connection(s) 610, 615, 620 may be backchannel connection(s)/link(s) similar to connection(s)/link(s) 245, 255 discussed with respect to FIGS. 2, 4A, and 4B.

FIG. 7 illustrates an audio system 700 according to one or more exemplary embodiments. The system 700 is similar to system 600, but includes an integrated mixer-transmitter device as illustrated in FIGS. 4A-5B. The audio system 700 may include mixer 401 or PSM transmitter 402, which are connectable to PSM receiver 104, and one or more electronic devices 110 (e.g., user devices). The electronic device 110 may be configured to communicate with the components of the system 700 to monitor and/or control, for example, the mixer 401 or PSM transmitter 402 (via connection 610), and/or the PSM receiver 104 (via connection 615). The controllers 210 and/or 220 of the mixer 401 or PSM transmitter 402, and/or the controller 230 of the PSM receiver 104, may be configured to transmit data, statuses, and/or other information to electronic device 110, and/or receive data, statuses, and/or other information from the electronic device 110. The exchange of such data, statuses, and/or other information may facilitate the monitoring and/or control of the mixer 401, PSM transmitter 402, and/or PSM receiver 104 by the electronic device(s) 110.

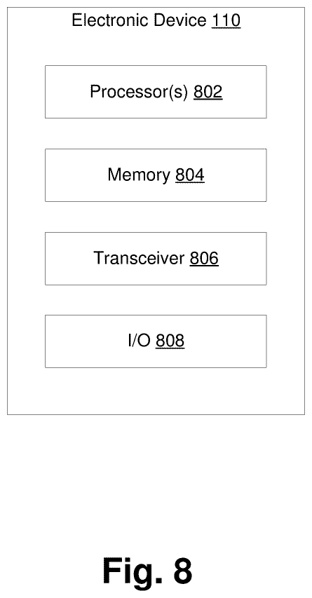

FIG. 8 illustrates the electronic device 110 according to an exemplary embodiment. The electronic device 110 may be a computing device (e.g., desktop computer, laptop computer), mobile computing device (e.g., smartphone, tablet), and/or any other type of device that may be used for one or more audio applications. The electronic device 110 may include one or more of processor(s) 802, memory 804, transceiver 806, and/or input/output (I/O) interface(s) 808. One or more data buses may interconnect the processor(s) 202, the memory 204, transceiver 806, and/or I/O interface(s) 208. The electronic device 110 may be implemented using one or more integrated circuits (ICs), software, or a combination thereof, configured to operate as described herein. The memory 804 may comprise any memory, such as a RAM, ROM, a flash memory, or any other electronically readable memory, or the like. The memory 804 may include one or more memory units. The processor(s) 802 may be configured to perform one or more operations of the electronic device 110, including monitoring and/or controlling the operation of the component(s) of the audio system. The processor(s) 802 may execute machine readable instructions stored in memory 804 to perform one or more operations of the electronic device 110. Signals received and/or output (e.g., via the I/O interface 808 and/or transceiver 806) by the electronic device 110 may be encoded in one or more data units. For example, the processor(s) 802 may be configured to generate data units, and process received data units, that conform to any suitable wired and/or wireless communication protocol. The transceiver 806 may be configured to receive/send signals from/to the electronic device 110 using one or more communication protocols according to the disclosure to communicate with the component(s) of the audio system.

The electronic device 110 may communicate with one or more components of the audio system (e.g., the mixer 101, the PSM transmitter 102, and/or PSM receiver 104) to monitor and/or control one or more operations of the component(s). As shown in FIGS. 6-7, the electronic device 110 may directly or indirectly communicate with (e.g., via Bluetooth, IEEE 802.11 protocol(s), etc.) the mixer 101, the PSM transmitter 102, and/or PSM receiver 104 to monitor and/or control the component(s). Additionally, or alternatively, the electronic device 110 may communicate with the mixer 101, the PSM transmitter 102, and/or PSM receiver 104 via a server (not shown) and/or one or more other devices of the audio system. The electronic device 110 may transmit and/or receive data to/from: the mixer via the I/O interface, the PSM transmitter 102 via the I/O interface 218 and/or transceiver 216, and/or the PSM receiver 104 via the I/O interface 228 and/or transceiver 226.

The electronic device 110 may include one or more applications that may be used for monitoring and/or control tasks (e.g., controlling one or more mixing and/or audio processing operations of the mixer 101, such as panning, equalizing, compressing, summing, device volume control, noise cancelation, power modes, power level adjustment, etc.). In an exemplary embodiment, the user of the electronic device 110 may adjust mixing parameters of the mixer 101 to adjust the mixing operations performed by the mixer 101. The adjustment may be based on data or information received from the mixer 101, PSM transmitter 102, PSM receiver 104, and/or one or more other components of the audio system.

In another example, the electronic device 110 may provide a user interface (e.g., via I/O interface 808) that may be used to monitor and/or control one or more components of the audio system. For example, the user interface may be used to input/control the configuration parameters, which may be provided to the mixer 101, PSM transmitter 102, and/or PSM receiver 104. The application(s) may display, via the electronic device 110, a current status of the mixer 101, PSM transmitter 102, and/or PSM receiver 104.

The electronic device 110 may be operated, for example, by the performer associated with the mixer, 101, PSM transmitter 102, and/or PSM receiver 104, a sound engineer at the sound booth/board, or one or more other persons/operators. For example, the performer can adjust mixing parameters (e.g. audio levels, EQ, and other parameters) of the mixer 101 using one or more applications on the electronic device 110. This allows for the performer to create a monitor mix that is tailored to their individual needs. The result is a high-quality, personalized monitoring experience that allows the performer to deliver their best possible performance on stage. In another example, the sound engineer may use the electronic device 110 to monitor and/or control operation of the mixer 101, PSM transmitter 102, and/or PSM receiver 102.

The electronic device 110 may present a user interface, such as graphical user interface (GUI) of the I/O interface 808, (e.g., via an installed application, or a web interface) that may be used to monitor and/or control operation of the component(s) of the audio system. The user associated with the electronic device 110 may access controls associated with the component(s), for example, by clicking/selecting an appropriate icon associated with the component(s) as illustrated in the GUI.

A user, associated with the electronic device 110, may authenticate themselves to enable monitoring and/or control of the component(s) of the audio system. For example, the user may input, via the user interface on the electronic device 110, an account identifier and password associated with a user account.

The techniques of this disclosure may also be described in the following paragraphs.

A personal stage monitor (PSM) device, such as a PSM receiver, may include a transceiver and a controller. The transceiver may be configured to receive one or more audio signals from an audio processing device (e.g., a PSM transmitter) using a first communication connection established between the transceiver and the PSM transmitter. The controller may be configured to communicate, using the transceiver and a second communication connection established between the transceiver and the PSM transmitter, with the PSM transmitter, to control the PSM transmitter. The controller may be configured to control the PSM transmitter to perform audio processing on one or more input audio signals to generate the one or more audio signals. The controller may be configured to control the PSM transmitter to adjust the audio processing performed on the one or more input audio signals to modify the one or more audio signals received by the transceiver. The controller may be configured to: receive (e.g., using the transceiver) status information from the PSM transmitter, and monitor an operation of the PSM transmitter (e.g., based on the status information). The controller may be configured to control the PSM transmitter based on the monitored operation of the PSM transmitter. The PSM receiver may be configured to be worn by a user of the PSM receiver. For example, the PSM receiver maybe be a PSM beltpack or bodypack worn by user. The PSM receiver may further include a user interface configured to receive a user input, wherein the controller is configured to control the PSM transmitter based on the user input. The first communication connection may use a first frequency band and the second communication connection may use a second frequency band. The first and the second frequency band may be different. The first communication connection may use a first communication protocol and the second communication connection may use a second communication protocol. The second communication protocol may be different from (or the same as) the first communication protocol. The PSM transmitter may include a mixer and a transceiver. The mixer may be configured to perform one or more mixing operations to generate the one or more audio signals. The transceiver of the PSM transmitter may be configured to communicate with the transceiver of the PSM receiver.

A personal stage monitor (PSM) system may include a PSM transmitter and a PSM receiver. The PSM transmitter may be configured to: process one or more audio signals to generate one or more respective processed audio signals, and transmit the one or more processed audio signals. The processing may include mixing the one or more audio signals. The PSM transmitter may be configured to perform panning, equalizing, and/or compression of the one or more audio signals to generate the one or more processed audio signals. The PSM receiver may be configured to: receive the one or more processed audio signals from the PSM transmitter, and control the PSM transmitter to adjust the processing of the one or more audio signals to cause the PSM transmitter to generate one or more adjusted processed audio signals. The PSM transmitter may include a first controller and the PSM receiver may include a second controller. The first and the second controllers may be configured to communicate with each other. For example, the second controller may be configured to communicate with the first controller of the PSM transmitter to cause the first controller to control the PSM transmitter to adjust the processing of the one or more audio signals. The PSM transmitter may additionally or alternatively include an audio processor and a transmitter frontend. The audio processor may be configured to process the one or more audio signals to generate the one or more respective processed audio signals. The transmitter frontend may be configured to transmit the one or more processed audio signals to the PSM receiver. The audio processor of the PSM transmitter may include a third controller. The second controller may be configured to communicate with the first controller and/or the third controller to cause the audio processor to adjust the processing of the one or more audio signals. The PSM system may include a user device configured to communicate with the PSM transmitter and control the processing of the one or more audio signals by the PSM transmitter.

A personal stage monitor (PSM) system may include a mixer and a PSM receiver. The mixer may be configured to: mix one or more audio signals to generate one or more respective processed audio signals, and transmit the one or more processed audio signals. The PSM receiver may be configured to: receive the one or more processed audio signals from the mixer, and control the mixer to adjust the mixing of the one or more audio signals to cause the mixer to generate one or more adjusted processed audio signals. The mixer may include personal mixer, a transceiver, and a first controller. Additionally, or alternatively, the PSM receiver may comprise a second controller. The personal mixer may be configured to perform one or more audio processing operations, such as panning, equalizing, and/or compression, of the one or more audio signals to generate the one or more processed audio signals. The transceiver may be configured to transmit the one or more processed audio signals to the PSM receiver. The first controller may be configured to control the personal mixer. The second controller may be configured to communicate with the first controller of the mixer to cause the first controller to control the personal mixer to adjust audio processing operation(s), such as adjusting the panning, equalizing, and/or compression, of the one or more audio signals. The transceiver of the mixer may include a third controller. The second controller may be configured to communicate with the first controller and/or the third controller to cause the personal mixer to adjust the panning, equalizing, and/or compression of the one or more audio signals.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A personal stage monitor (PSM) receiver comprising:
a transceiver configured to receive one or more audio signals from a PSM transmitter using a first communication connection established between the transceiver and the PSM transmitter; and
a controller configured to communicate, using the transceiver and a second communication connection established between the transceiver and the PSM transmitter, with the PSM transmitter, to control the PSM transmitter.

2. The PSM receiver of claim 1, wherein the controller is configured to control the PSM transmitter to perform audio processing on one or more input audio signals to generate the one or more audio signals.

3. The PSM receiver of claim 2, wherein the controller is configured to control the PSM transmitter to adjust the audio processing performed on the one or more input audio signals to modify the one or more audio signals received by the transceiver.

4. The PSM receiver of claim 1, wherein the controller is further configured to:
receive, using the transceiver, status information from the PSM transmitter; and
monitor an operation of the PSM transmitter based on the status information.

5. The PSM receiver of claim 4, wherein the controller is configured to control the PSM transmitter based on the monitored operation of the PSM transmitter.

6. The PSM receiver of claim 1, further comprising a user interface configured to receive a user input, wherein the controller is configured to control the PSM transmitter based on the user input.

7. The PSM receiver of claim 1, wherein the first communication connection uses a first frequency band and the second communication connection uses a second frequency band different from the first frequency band.

8. The PSM receiver of claim 1, wherein the first communication connection uses a first communication protocol and the second communication connection use a second communication protocol different from the first communication protocol.

9. The PSM receiver of claim 1, wherein PSM transmitter comprises:
a mixer configured to perform one or more mixing operations to generate the one or more audio signals; and
a transceiver configured to communicate with the transceiver of the PSM receiver.

10. The PSM receiver of claim 1, wherein the PSM receiver is configured to be worn by a user of the PSM receiver.

11. A personal stage monitor (PSM) system comprising:
a PSM transmitter configured to: process one or more audio signals to generate one or more respective processed audio signals, the processing including mixing the one or more audio signals; and transmit the one or more processed audio signals; and
a PSM receiver configured to:
receive the one or more processed audio signals from the PSM transmitter; and
control the PSM transmitter to adjust the processing of the one or more audio signals to cause the PSM transmitter to generate one or more adjusted processed audio signals.

12. The PSM system of claim 11, wherein the PSM transmitter comprises a first controller, and the PSM receiver comprises a second controller configured to communicate with the first controller of the PSM transmitter to cause the first controller to control the PSM transmitter to adjust the processing of the one or more audio signals.

13. The PSM system of claim 11, wherein the PSM transmitter comprises:
an audio processor configured to process the one or more audio signals to generate the one or more respective processed audio signals; and
a transmitter frontend configured to transmit the one or more processed audio signals to the PSM receiver.

14. The PSM system of claim 13, wherein the PSM transmitter further comprises a first controller, and the PSM receiver comprises a second controller configured to communicate with the first controller of the PSM transmitter to cause the first controller to control the PSM transmitter to adjust the processing of the one or more audio signals.

15. The PSM system of claim 14, wherein the audio processor of the PSM transmitter comprises a third controller, the second controller configured to communicate with the first controller and/or the third controller to cause the audio processor to adjust the processing of the one or more audio signals.

16. The PSM system of claim 11, wherein the PSM transmitter is configured to perform panning, equalizing, and/or compression of the one or more audio signals to generate the one or more processed audio signals.

17. The PSM system of claim 11, further comprising a user device configured to communicate with the PSM transmitter and control the processing of the one or more audio signals by the PSM transmitter.

18. A personal stage monitor (PSM) system comprising:
a mixer configured to: mix one or more audio signals to generate one or more respective processed audio signals, and transmit the one or more processed audio signals; and
a PSM receiver configured to:
receive the one or more processed audio signals from the mixer; and
control the mixer to adjust the mixing of the one or more audio signals to cause the mixer to generate one or more adjusted processed audio signals.

19. The PSM system of claim 18, wherein:
the mixer comprises:
personal mixer configured to perform panning, equalizing, and/or compression of the one or more audio signals to generate the one or more processed audio signals;
a transceiver configured to transmit the one or more processed audio signals to the PSM receiver; and
a first controller configured to control the personal mixer; and
the PSM receiver comprises a second controller configured to communicate with the first controller of the mixer to cause the first controller to control the personal mixer to adjust the panning, equalizing, and/or compression of the one or more audio signals.

20. The PSM system of claim 19, wherein the transceiver of the mixer comprises a third controller, the second controller configured to communicate with the first controller and/or the third controller to cause the personal mixer to adjust the panning, equalizing, and/or compression of the one or more audio signals.
